(19) United States
(12) Patent Application Publication
(10) Pub. No.: US 2022/0156742 A1
(43) Pub. Date: May 19, 2022

(54) SYSTEM AND METHOD FOR AUTHORIZING A TRANSACTION

(71) Applicant: Visa International Service Association, San Francisco, CA (US)

(72) Inventor: Anurag Gupta, Sammamish, WA (US)

(21) Appl. No.: 17/435,748

(22) PCT Filed: Jun. 12, 2019
(86) PCT No.: PCT/US2019/036769

§ 371 Date: Sep. 2, 2021

(51) Int. Cl. G06Q 20/40; H04L 9/40

(52) U.S. Cl. CPC G06Q 20/4014; H04L 63/10

(57) ABSTRACT

A method, system, and computer program product is provided for authorizing a transaction. The method includes registering, with a first merchant system associated with a first merchant, a second merchant system associated with a second merchant, receiving, from the second merchant system, user data associated with a user requesting a transaction through the second merchant system, determining, with the first merchant system, a user profile for the user based on the user data, the user profile stored on a data storage device that is not accessible to the second merchant system, the user profile including an account identifier, obtaining, with the first merchant system, a transaction token generated based on the account identifier, and transmitting, to the second merchant system, the transaction token.

### CROSS-REFERENCE TO RELATED APPLICATION

This application is the United States national phase of International Application No. PCT/US2019/036769 filed Jun. 12, 2019, the entire disclosure of which is hereby incorporated by reference in its entirety.

### BACKGROUND

### 1. Technical Field

This disclosure relates generally to authorizing transactions and, in non-limiting embodiments or aspects, systems, methods, and computer program products for authorizing a transaction.

### 2. Technical Considerations

Merchants utilize different systems for conducting transactions with customers, such as different payment gateway systems, different payment networks, and the like. Merchants that process infrequent transactions from many different users may not have robust databases of customer information. As a result, customers may avoid transacting with such merchants due to the inconvenience and/or security risks associated with entering payment information.

### SUMMARY

According to non-limiting embodiments or aspects, provided is a computer-implemented method for authorizing a transaction, comprising: registering, with a first merchant system associated with a first merchant, a second merchant system associated with a second merchant; receiving, from the second merchant system, user data associated with a user requesting a transaction through the second merchant system; determining, with the first merchant system, a user profile for the user based on the user data, the user profile stored on a data storage device that is not accessible to the second merchant system, the user profile including an account identifier; obtaining, with the first merchant system, a transaction token generated based on the account identifier; and transmitting, to the second merchant system, the transaction token.

In non-limiting embodiments or aspects, obtaining the transaction token comprises: transmitting, with the first merchant system, a request for the transaction token to a token service; and receiving, from the token service, the transaction token. In non-limiting embodiments or aspects, the request comprises an access token unique to the second merchant system. In non-limiting embodiments or aspects, the method further comprises: receiving, from the second merchant system, a registration request; in response to receiving the registration request, redirecting the second merchant system to an authorization application; and receiving, with the first merchant system, an authorization code associated with the second merchant system. In non-limiting embodiments or aspects, the method further comprises exchanging the authorization code for an access token. In non-limiting embodiments or aspects, the method further comprises: receiving, with the second merchant system, the transaction token; and initiating, with the second merchant system, a transaction based on the transaction token.

According to non-limiting embodiments or aspects, provided is a computer-implemented method for authorizing a transaction, comprising: receiving, from a first merchant system associated with a first merchant, a request for a transaction token, the request comprising user data associated with a user requesting a transaction through a second merchant system associated with a second merchant; generating, with at least one processor, the transaction token based on an account identifier associated with the user, the second merchant system does not have access to the account identifier associated with the user; transmitting the transaction token to the first merchant system; receiving, from the second merchant system, a transaction request message comprising the transaction token, the transaction request message corresponding to the transaction requested by the user through the second merchant system; and processing, with at least one processor, the transaction using the transaction token.

In non-limiting embodiments or aspects, the request for the transaction token comprises an access token. In non-limiting embodiments or aspects, the method further comprises: communicating an authorization code to the first merchant system; and generating the access token in response to receiving the authorization code from the first merchant system. In non-limiting embodiments or aspects, the method further comprises: receiving, from the second merchant system through an authorization application, an API access request identifying the first merchant system, the second merchant system is directed to the authorization application by the first merchant system; and in response to receiving the API access request, redirecting the second merchant system to the first merchant system.

According to non-limiting embodiments or aspects, provided is a system for authorizing a transaction, comprising a first merchant system including at least one processor, the first merchant system programmed or configured to: register a second merchant system associated with a second merchant; receive, from the second merchant system, user data associated with a user requesting a transaction through the second merchant system; determine a user profile for the user based on the user data, the user profile stored on a data storage device that is not accessible to the second merchant system, the user profile including an account identifier; obtain a transaction token that is generated based on the account identifier; and transmit, to the second merchant system, the transaction token.

In non-limiting embodiments or aspects, the first merchant system obtains the transaction token by: transmitting a request for the transaction token to a token service; and receiving, from the token service, the transaction token. In non-limiting embodiments or aspects, the request comprises an access token unique to the second merchant system. In non-limiting embodiments or aspects, the first merchant system is further programmed or configured to: receive, from the second merchant system, a registration request; in response to receiving the registration request, redirect the second merchant system to an authorization application; and receive an authorization code associated with the second merchant system. In non-limiting embodiments or aspects, the first merchant system is further programmed or configured to exchange the authorization code for an access token. In non-limiting embodiments or aspects, the second merchant system includes at least one processor programmed or configured to: receive the transaction token; and initiate a transaction based on the transaction token.

According to non-limiting embodiments or aspects, provided is a system for authorizing a transaction, comprising at least one processor programmed or configured to: receive a request for a transaction token, the request comprising user data associated with a user requesting a transaction through a second merchant system associated with a second merchant; generate the transaction token based on an account identifier associated with the user, the second merchant system does not have access to the account identifier associated with the user; communicate the transaction token to the first merchant system; receive, from the second merchant system, a transaction request message comprising the transaction token, the transaction request message corresponding to the transaction requested by the user through the second merchant system; and process the transaction using the transaction token.

In non-limiting embodiments or aspects, the request for the transaction token comprises an access token. In non-limiting embodiments or aspects, the at least one processor is further programmed or configured to: communicate an authorization code to the first merchant system; and generate the access token in response to receiving the authorization code from the first merchant system. In non-limiting embodiments or aspects, the at least one processor is further programmed or configured to: receive, from the second merchant system through an authorization application, an API access request identifying the first merchant system, the second merchant system is directed to the authorization application by the first merchant system; and in response to receiving the API access request, redirect the second merchant system to the first merchant system.

According to non-limiting embodiments or aspects, provided is a computer-implemented method of authorizing a transaction, comprising: receiving, by a first merchant system, a request from a second merchant system associated with a transaction request between a user and the second merchant system; generating, by the first merchant system, a token request message comprising authentication data associated with an account of the user; communicating, by the first merchant system, the token request message to a token system; receiving, by the first merchant system, a transaction token from the token system, the transaction token corresponding to the account of the user; and communicating, by the first merchant system, the transaction token to the second merchant system.

According to non-limiting embodiments or aspects, provided is a computer-implemented method of authorizing a transaction, comprising: receiving, by at least one processor of a token system, a token request message from a first merchant system, the token request message comprising an identifier of a second merchant system and authentication data associated with an account of the user; generating, by the at least one processor, a transaction token based on the account of the user; communicating, by the at least one processor, the transaction token to the first merchant system; receiving, by a transaction processing system, a transaction request from the second merchant system, the transaction request comprising the transaction token; and processing, by the transaction processing system, the transaction request based on the transaction token.

According to some non-limiting embodiments or aspects, provided is a computer program product for authorizing a transaction, comprising at least one non-transitory computer-readable medium including program instructions that, when executed by a processor of a first merchant system, causes the first merchant system to: register a second merchant system associated with a second merchant; receive, from the second merchant system, user data associated with a user requesting a transaction through the second merchant system; determine a user profile for the user based on the user data, the user profile stored on a data storage device that is not accessible to the second merchant system, the user profile including an account identifier; obtain a transaction token that is generated based on the account identifier; and transmit, to the second merchant system, the transaction token.

According to some non-limiting embodiments or aspects, provided is a computer program product for authorizing a transaction, comprising at least one non-transitory computer-readable medium including program instructions that, when executed by a processor, causes the processor to: receive a request for a transaction token, the request comprising user data associated with a user requesting a transaction through a second merchant system associated with a second merchant; generate the transaction token based on an account identifier associated with the user, wherein the second merchant system does not have access to the account identifier associated with the user; communicate the transaction token to the first merchant system; receive, from the second merchant system, a transaction request message comprising the transaction token, the transaction request message corresponding to the transaction requested by the user through the second merchant system; and process the transaction using the transaction token.

Other non-limiting embodiments or aspects will be set forth in the following numbered clauses:

Clause 1: A computer-implemented method for authorizing a transaction, comprising: registering, with a first merchant system associated with a first merchant, a second merchant system associated with a second merchant; receiving, from the second merchant system, user data associated with a user requesting a transaction through the second merchant system; determining, with the first merchant system, a user profile for the user based on the user data, the user profile stored on a data storage device that is not accessible to the second merchant system, the user profile including an account identifier; obtaining, with the first merchant system, a transaction token generated based on the account identifier; and transmitting, to the second merchant system, the transaction token.

Clause 2: The computer-implemented method of clause 1, wherein obtaining the transaction token comprises: transmitting, with the first merchant system, a request for the transaction token to a token service; and receiving, from the token service, the transaction token.

Clause 3: The computer-implemented method of clauses 1 or 2, wherein the request comprises an access token unique to the second merchant system.

Clause 4: The computer-implemented method of any of clauses 1-3, further comprising: receiving, from the second merchant system, a registration request; in response to receiving the registration request, redirecting the second merchant system to an authorization application; and receiving, with the first merchant system, an authorization code associated with the second merchant system.

Clause 5: The computer-implemented method of any of clauses 1-4, further comprising exchanging the authorization code for an access token.

Clause 6: The computer-implemented method of any of clauses 1-5, further comprising: receiving, with the second merchant system, the transaction token; and initiating, with the second merchant system, a transaction based on the transaction token.

Clause 7: A computer-implemented method for authorizing a transaction, comprising: receiving, from a first merchant system associated with a first merchant, a request for a transaction token, the request comprising user data associated with a user requesting a transaction through a second merchant system associated with a second merchant; generating, with at least one processor, the transaction token based on an account identifier associated with the user, the second merchant system does not have access to the account identifier associated with the user; transmitting the transaction token to the first merchant system; receiving, from the second merchant system, a transaction request message comprising the transaction token, the transaction request message corresponding to the transaction requested by the user through the second merchant system; and processing, with at least one processor, the transaction using the transaction token.

Clause 8: The computer-implemented method of clause 7, wherein the request for the transaction token comprises an access token.

Clause 9: The computer-implemented method of clauses 7 or 8, further comprising: communicating an authorization code to the first merchant system; and generating the access token in response to receiving the authorization code from the first merchant system.

Clause 10: The computer-implemented method of any of clauses 7-9, further comprising: receiving, from the second merchant system through an authorization application, an API access request identifying the first merchant system, the second merchant system is directed to the authorization application by the first merchant system; and in response to receiving the API access request, redirecting the second merchant system to the first merchant system.

Clause 11: A system for authorizing a transaction, comprising a first merchant system including at least one processor, the first merchant system programmed or configured to: register a second merchant system associated with a second merchant; receive, from the second merchant system, user data associated with a user requesting a transaction through the second merchant system; determine a user profile for the user based on the user data, the user profile stored on a data storage device that is not accessible to the second merchant system, the user profile including an account identifier; obtain a transaction token that is generated based on the account identifier; and transmit, to the second merchant system, the transaction token.

Clause 12: The system of clause 11, wherein the first merchant system obtains the transaction token by: transmitting a request for the transaction token to a token service; and receiving, from the token service, the transaction token.

Clause 13: The system of clauses 11 or 12, the request comprising an access token unique to the second merchant system.

Clause 14: The system of any of clauses 11-13, wherein the first merchant system is further programmed or configured to: receive, from the second merchant system, a registration request; in response to receiving the registration request, redirect the second merchant system to an authorization application; and receive an authorization code associated with the second merchant system.

Clause 15: The system of any of clauses 11-14, wherein the first merchant system is further programmed or configured to exchange the authorization code for an access token.

Clause 16: The system of any of clauses 11-15, further comprising the second merchant system, the second merchant system including at least one processor programmed or configured to: receive the transaction token; and initiate a transaction based on the transaction token.

Clause 17: A system for authorizing a transaction, comprising at least one processor programmed or configured to: receive a request for a transaction token, the request comprising user data associated with a user requesting a transaction through a second merchant system associated with a second merchant; generate the transaction token based on an account identifier associated with the user, the second merchant system does not have access to the account identifier associated with the user; communicate the transaction token to the first merchant system; receive, from the second merchant system, a transaction request message comprising the transaction token, the transaction request message corresponding to the transaction requested by the user through the second merchant system; and process the transaction using the transaction token.

Clause 18: The system of clause 17, the request for the transaction token comprises an access token.

Clause 19: The system of clauses 17 or 18, the at least one processor is further programmed or configured to: communicate an authorization code to the first merchant system; and generate the access token in response to receiving the authorization code from the first merchant system.

Clause 20: The system of any of clauses 17-19, the at least one processor is further programmed or configured to: receive, from the second merchant system through an authorization application, an API access request identifying the first merchant system, the second merchant system is directed to the authorization application by the first merchant system; and in response to receiving the API access request, redirect the second merchant system to the first merchant system.

Clause 21: A computer-implemented method of authorizing a transaction, comprising: receiving, by a first merchant system, a request from a second merchant system associated with a transaction request between a user and the second merchant system; generating, by the first merchant system, a token request message comprising authentication data associated with an account of the user; communicating, by the first merchant system, the token request message to a token system; receiving, by the first merchant system, a transaction token from the token system, the transaction token corresponding to the account of the user; and communicating, by the first merchant system, the transaction token to the second merchant system.

Clause 22: A computer-implemented method of authorizing a transaction, comprising: receiving, by at least one processor of a token system, a token request message from a first merchant system, the token request message comprising an identifier of a second merchant system and authentication data associated with an account of the user; generating, by the at least one processor, a transaction token based on the account of the user; communicating, by the at least one processor, the transaction token to the first merchant system; receiving, by a transaction processing system, a transaction request from the second merchant system, the transaction request comprising the transaction token; and processing, by the transaction processing system, the transaction request based on the transaction token.

Clause 23: A computer program product for authorizing a transaction, comprising at least one non-transitory computer-readable medium including program instructions that, when executed by a processor of a first merchant system, causes the first merchant system to: register a second merchant system associated with a second merchant; receive, from the second merchant system, user data associated with a user requesting a transaction through the second merchant system; determine a user profile for the user based on the user data, the user profile stored on a data storage device that is not accessible to the second merchant system, the user profile including an account identifier; obtain a transaction token that is generated based on the account identifier; and transmit, to the second merchant system, the transaction token.

Clause 24: A computer program product for authorizing a transaction, comprising at least one non-transitory computer-readable medium including program instructions that, when executed by a processor, causes the processor to: receive a request for a transaction token, the request comprising user data associated with a user requesting a transaction through a second merchant system associated with a second merchant; generate the transaction token based on an account identifier associated with the user, wherein the second merchant system does not have access to the account identifier associated with the user; communicate the transaction token to the first merchant system; receive, from the second merchant system, a transaction request message comprising the transaction token, the transaction request message corresponding to the transaction requested by the user through the second merchant system; and process the transaction using the transaction token.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for authorizing a transaction according to some non-limiting embodiments or aspects;

FIG. 2 is a sequence diagram for a method of authorizing a transaction according to some non-limiting embodiments or aspects;

FIG. 3 is a flow diagram for a method of authorizing a transaction according to some non-limiting embodiments or aspects;

FIG. 4 is a flow diagram for a method of authorizing a transaction according to some non-limiting embodiments or aspects; and

FIG. 5 illustrates example components of a device used in connection with non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments or aspects, may be operated by or on behalf of a transaction service provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computing devices operated by or on behalf of an issuer institution, such as a server computer executing one or more software applications. For example, an issuer system may include one or more authorization servers for authorizing a transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “account identifier” may include one or more PANs, tokens, or other identifiers associated with a customer account. The term “payment token” may refer to an identifier that is used as a substitute or replacement identifier for an original account identifier, such as a PAN. Account identifiers may be alphanumeric or any combination of characters and/or symbols. Payment tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of payment tokens for different individuals or purposes.

As used herein, the term “merchant” may refer to an individual or entity that provides goods and/or services, or access to goods and/or services, to customers based on a transaction, such as a payment transaction. As used herein, the terms “merchant” or “merchant system” may also refer to one or more computer systems operated by or on behalf of a merchant, such as a server computer executing one or more software applications. As used herein, the term “point-of-sale (POS) system,” may refer to one or more computing devices and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems. As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

As used herein, the term “token service” may refer to an entity including one or more server computers in a token service system that generates, processes, and maintains payment tokens. The token service may include or be in communication with a token vault where the generated tokens are stored. Specifically, the token vault may maintain one-to-one mapping between a token and a PAN represented by the token.

As used herein, the term “token vault” may refer to a repository that maintains established token-to-PAN mappings. According to various embodiments or aspects, the token vault may also maintain other attributes of the token requestor that may be determined at the time of registration and that may be used by the token service provider to apply domain restrictions or other controls during transaction processing. The token vault may be a part of a token service system. In some embodiments or aspects, the token vault may be provided as a part of the token service. Alternatively, the token vault may be a remote repository accessible by the token service. Token vaults, due to the sensitive nature of the data mappings that are stored and managed in them, may be protected by strong underlying physical and logical security. A token vault may be operated by any suitable entity, including a payment network, an issuer, clearing houses, other financial institutions, or any other entity.

Non-limiting embodiments or aspects of a system and method for authorizing a transaction allow for a merchant system to conduct transactions with a user without having access to the user's payment device or account information. Non-limiting embodiments or aspects leverage another merchant system, associated with a trusted merchant that the user transacts with, to effectuate a secure transaction from an untrusted or less trusted merchant system. In addition to providing enhanced security, this unique arrangement of two or more merchant systems and tokenization also provides multiple efficiencies by enabling transactions to occur without the need for reentering account information.

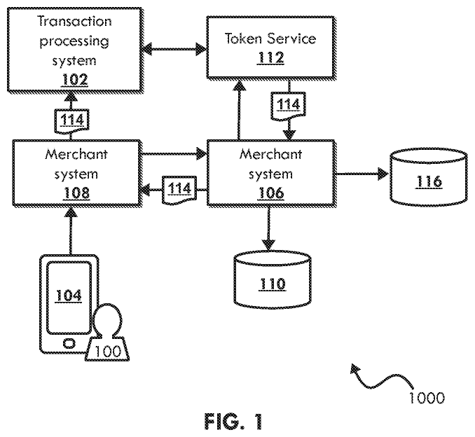

FIG. 1 depicts a system 1000 for authorizing a transaction according to some non-limiting embodiments or aspects. The system 1000 includes a first merchant system 106 associated with a first merchant (e.g., a master merchant), a second merchant system 108 associated with a second merchant (e.g., a connected merchant), a token service 112, a transaction processing system 102, and a user device 104 operated by a user 100. The first merchant system 106 may be in communication with the second merchant system 108 via one or more network environments, such as the Internet or a private network. The first merchant system 106 may also be in communication with the token service 112 via one or more network environments, such as the Internet or a private network. Although the non-limiting example in FIG. 1 shows the second merchant system 108 communicating directly with the transaction processing system 102, it will be appreciated that the second merchant system 108 may communicate directly with a payment gateway system that may be internal or external to the transaction processing system 102. For example, some or all of the actions described herein as being performed by the transaction processing system 102 may be performed by a payment gateway system.

With continued reference to FIG. 1, the token service 112 may include one or more computing devices and/or software applications executing on one or more computing devices configured to generate, process, and/or retrieve payment tokens. The token service 112 is illustrated in FIG. 1 as separate from the transaction processing system 102, but it will be appreciated that the token service 112 may be part of the transaction processing system 102, may be part of an issuer system (not shown in FIG. 1), or may be a separate system. The token service 112 is in communication with a data storage device 116 including a token vault.

Still referring to FIG. 1, the first merchant system 106 may be in communication with a user profile database 110 that stores user information associated with customers of the first merchant corresponding to the first merchant system 106. Accordingly, the first merchant system 106 may be associated with a merchant with which the user 100 has already interacted. For example, the user 100 may have purchased one or more items through the first merchant system 106 and/or with a merchant associated with the first merchant system 106 such that user information associated with the user 100 is stored in the user profile database 110 as user profile data. The user profile data stored in the user profile database 110 may include one or more account identifiers, such as PANs or account tokens, associated with one or more payment devices of the user 100, expiration dates for one or more payment devices, purchase histories, other transaction information, and/or user attributes (e.g., name, address, phone number, etc.). The first merchant system 106 may also store registration information for one or more other merchant systems, such as the second merchant system 108.

Through an on-boarding process, the first merchant system 106 may register the second merchant system 108 and store merchant data associated with the second merchant system 108 such as, for example, one or more network addresses, access tokens, and/or the like. For example, during a registration (e.g., on-boarding) process, the second merchant system 108 may transmit a registration request to the first merchant system 106. The first merchant system 106 may approve or deny the registration request based on one or more parameters. The first merchant system 106 may, in response to the registration request, redirect the second merchant system 108 to an authorization application. The authorization application may return an authorization code to the first merchant system 106 in response to authorizing the second merchant system 108. The authorization code may be a one-time authorization code that is used only once by the first merchant system and then expires. The first merchant system 106 may then exchange the authorization code for an access token that is utilized by the first merchant system 106 to obtain a transaction token 114 for a transaction originating with the second merchant system 108. The first merchant system 106 may store a plurality of authorization codes and/or access tokens for conducting transactions with a plurality of different merchant systems. The access token may be any data element unique to the second merchant and/or first merchant that is used to verify that the first merchant is authorized to request the transaction token. In non-limiting embodiments or aspects, an access token may be a short-lived bearer token that can be used for a limited time period or number of transactions. A transaction token may be a payment token that is purposed for a particular transaction.

In some non-limiting embodiments or aspects, user device 104 requests a transaction with the second merchant system 108. For example, a user 100 may request to purchase an item or service through a webpage associated with the second merchant system 108 that is accessed by the user device 104. The second merchant system 108, in response to the user's request, may generate an initial transaction request message including user information (e.g., name, email address, phone number, unique identifier, etc.), a transaction value, and/or other transaction or user information. The second merchant system 108 may then communicate the transaction request message to the first merchant system 106. In response to receiving the transaction request message, the first merchant system 106 may query the user profile database 110 with the user identifier to obtain user profile data. In some non-limiting examples, the first merchant system 106 may first determine the user identifier based on the user information provided by the second merchant system 108 if the user identifier is not provided. The user profile data may include account data that was not provided to the second merchant system 108, such as a PAN or account token, expiration date, verification code, and/or the like. In this manner, the second merchant system 108 does not have access to sensitive account data.

With continued reference to FIG. 1, after obtaining the user profile data, the first merchant system 106 may authenticate the second merchant system 108 and/or determine that the second merchant system 108 is registered with the first merchant system 106. In response to determining that the second merchant system 108 is verified and registered with the first merchant system, the first merchant system 106 may generate a token request message and communicate the token request message to the token service 112. In non-limiting embodiments or aspects, the token request message includes an access token unique to the second merchant system 108 that is stored by the first merchant system 106 and obtained during the registration process.

Still referring to FIG. 1, in response to receiving the token request message, the token service 112 may generate a transaction token 114 and/or retrieve a transaction token 114 from a token vault 116. The transaction token 114 may be a one-time limited use payment token that can be utilized for a single transaction based on specified rules. The transaction token 114 may also be referred to as a “shared token” as it is shared between a master merchant and a connected merchant. The token service 112 may communicate the transaction token 114 to the first merchant system 106 which, in turn, communicates the transaction token 114 to the second merchant system 108. It will be appreciated, however, that the token service 112 may also communicate the transaction token 114 to the second merchant system 108 directly or, in other examples, may communicate the transaction token 114 to the user device 104 to be separately input or provided to the second merchant system 108 by the user 100.

With continued reference to FIG. 1, in non-limiting embodiments in which the second merchant system 108 receives the transaction token 114, the second merchant system 108 generates another transaction request message based on the transaction token 114 and user information previously provided by the user 100. The transaction request message may be formatted for processing by the transaction processing system 102 and/or a payment gateway (not shown in FIG. 1). Accordingly, the initial transaction request message generated for communication to the first merchant system may differ in format and content from the transaction request message generated for communication to the transaction processing system 102 or payment gateway including the transaction token. The transaction processing system 102 may process the transaction request message by exchanging the transaction token 114 for a payment token or other account identifier from the token service 112.

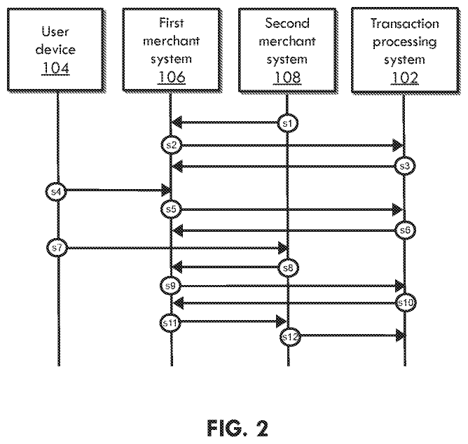

Referring now to FIG. 2, a sequence diagram is shown for a system and method for authorizing a transaction according to some non-limiting embodiments or aspects. It will be appreciated that the transaction processing system 102 in FIG. 2 may represent both a payment gateway system and a transaction processing system. At step s1, a second merchant system 108 (e.g., a connected merchant) transmits a registration request (e.g., an on-boarding request) to the first merchant system 106 (e.g., a master merchant). At step s2, the first merchant system 106 may then redirect the second merchant system 108 to the transaction processing system 102 or, in other examples, transmit inputted data from the second merchant system 108 to the transaction processing system 102. Once the second merchant system 108 becomes registered with the first merchant system 106 and/or transaction processing system 102, the transaction processing system 102 may generate an access token and transmit the access token to the first merchant system 106 at step s3. In other non-limiting examples, the transaction processing system 102 may first generate an authorization code that is transmitted to a payment gateway system and, then, from the payment gateway system to the first merchant system 106. The first merchant system 106 may then exchange the authorization code for the access token. Other variations are possible.

With continued reference to FIG. 2, at step s4, the user device 104 initiates a transaction with the first merchant system 106 and, as part of that transaction, provides user data (e.g., account data and other user information) to the first merchant system 106. It will be appreciated that step s4 can be completed at any time, including prior to step s1. In response to the transaction or in response to the registration of the second merchant system 108, the first merchant system 106 creates a user profile at step s5 and, in some examples, transmits the user profile or a portion thereof to the transaction processing system 102. In such examples, at step s6, the transaction processing system 102 may return a user identifier to the first merchant system 106 in response to receiving the user profile. However, it will be appreciated that, in some non-limiting embodiments or aspects, the first merchant system 106 may create a user identifier on its own or utilize an API associated with the transaction processing system 102, a payment gateway system, or a third-party service provider, as examples. The first merchant system 106 stores the user profile and user identifier so that the user can make purchases with the first merchant system 106 using stored account information (e.g., PAN or other account identifier, expiration date, verification code, PIN, address, and/or the like) that is part of the user profile data.

Still referring to FIG. 2, at step s7 the user device 104 requests a transaction with the second merchant system 108. For example, a user operating the user device 104 may navigate to a website or application associated with the second merchant system 108 and request a transaction. The user may provide user information such as, for example, name, email address, physical address, phone number, birthdate, user identifier, and/or the like. In other examples, the user operating the user device 104 may request the transaction with the second merchant system 108 through the first merchant system 106 (e.g., through a listing on a webpage of the first merchant). At step s8, the second merchant system 108 transmits an initial transaction request message to the first merchant system 106 including the user information provided by the user device 104 at step s7. The first merchant system 106 may then query a user profile database based on the user information. The first merchant system 106 may also query the transaction processing system 102, a payment gateway system, or a third-party service provider to obtain a user identifier based on available user information. Once the user identifier is determined to be available (e.g., the first merchant system 106 has access to a user profile for the user), the first merchant system 106 requests a transaction token from the transaction processing system 102 at step s9 by transmitting a token request message. The request for the transaction token may be transmitted to the transaction processing system 102 or directly to a token service that is part of or in communication with the transaction processing system 102. The request for the transaction token may include the access token that the first merchant system 106 stores in association with the user profile data.

Still referring to FIG. 2, at step s10, the transaction processing system 102 transmits a transaction token to the first merchant system 106. The transaction token may also be transmitted to the first merchant system 106 from a token service, payment gateway, or other system. At step s11, the transaction token is transmitted from the first merchant system 106 to the second merchant system 108. However, it will be appreciated that, in other non-limiting examples, the transaction token may be transmitted directly to the second merchant system 108 from the transaction processing system 102, token service, or other system. At step s12, the second merchant system 108 generates a transaction request message based on the transaction token and transmits the transaction request message to the transaction processing system 102. The transaction processing system 102 may then process the transaction using the transaction token by communicating with a token service.

In non-limiting embodiments or aspects, the system and method for authorizing a transaction may be performed for both card-present and card-not-present transactions (e.g., in-person transactions, web-based transactions, telephone-initiated transactions, and/or the like). As an example, a user (customer) may have a user profile stored with an online retailer (e.g., master merchant) that the user trusts and that has an active account with a payment gateway system or transaction processing system for initiating transactions. The user may wish to make a purchase with another retailer, such as a small pizza shop, and request the transaction directly through a merchant system associated with the pizza shop and/or through a merchant system associated with the master merchant. As an example, the user may navigate a website associated with the master merchant and, through the master merchant website, select the pizza shop from a plurality of affiliated merchants. As another example, the user may navigate a website associated with the pizza shop and input user information (e.g., credentials) that allows the pizza shop website to query the merchant system associated with the master merchant. In some examples, a user device may be redirected from the pizza shop website to the master merchant website. The merchant system associated with the master merchant may then request a transaction token for the particular transaction and pass that transaction token to the merchant system associated with the pizza shop.

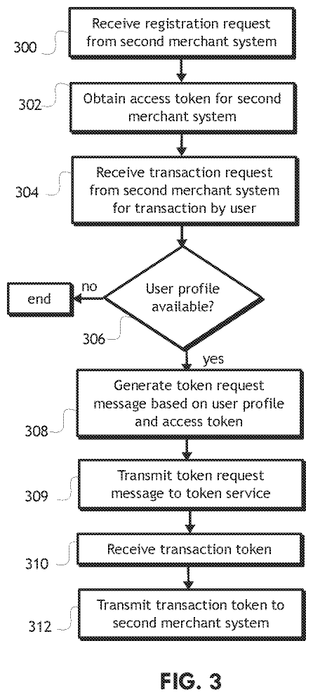

Referring now to FIG. 3, a flow diagram is shown for a system and method for authorizing a transaction according to some non-limiting embodiments or aspects. It will be appreciated that the flow diagram is shown for exemplary purposes only and that the method may include fewer, additional, and/or different steps, and that the steps may be performed in any order. The flow diagram shown in FIG. 3 is from the perspective of a first merchant system (e.g., master merchant). At step 300, the first merchant system receives a registration request from a second merchant system as part of an on-boarding or registration process. The registration request may include merchant data associated with the second merchant system. If the first merchant system approves the registration request, at step 302 the first merchant system obtains an access token for the second merchant system. As an example, the first merchant system may communicate with a token service, transaction processing system, and/or payment gateway system to request an access token that permits the first merchant system to obtain transaction tokens for the second merchant system.

With continued reference to FIG. 3, at step 304 a transaction request message is received from the second merchant system for conducting a transaction with a user. As an example, a user may request a transaction through a website of the second merchant which invokes one or more APIs for sending a transaction request to the first merchant system. Once the first merchant system receives the transaction request message, which may include user information, the first merchant system may determine at step 306 that a user profile data is available for the user requesting the transaction. For example, a user profile database may be queried based on the user information. In some examples, a user identifier may be used to uniquely identify different users associated with different profiles. If a user profile is not available at step 306, the method may end. If a user profile is available for the user at step 306, the method may proceed to step 308 and a token request message may be generated based on the user profile data and the access token. For example, in response to determining that a user profile is available for the user, the first merchant system may generate a token request message that includes the user identifier, transaction data (e.g., second merchant identifier, transaction value, merchant category code, and/or the like), account data (e.g., one or more PANs or other account identifiers, expiration dates, verification codes, and/or the like), and the access token obtained at step 302.

With continued reference to FIG. 3, at step 309 the token request message is transmitted to the token service which, in response to the token request message, generates and/or obtains a transaction token, which may be a one-time limited use payment token that is limited to use by the second merchant, a specified transaction value, and/or a time limit (e.g., 15 minutes), as examples. At step 310, the first merchant system receives the transaction token from the token service and, at step 312, transmits the transaction token to the second merchant system. The second merchant system is then able to generate a transaction request message based on the transaction token and transmit the transaction request message to a payment gateway system and/or transaction processing system. It will be appreciated, however, that the token service, transaction processing system, and/or payment gateway system may transmit the transaction token to the second merchant system. It will also be appreciated that, in some non-limiting embodiments or aspects, the transaction token may be transmitted to a user device operated by the user requesting the transaction, provisioned on the user device, and used by the user device to complete a transaction with the second merchant system.

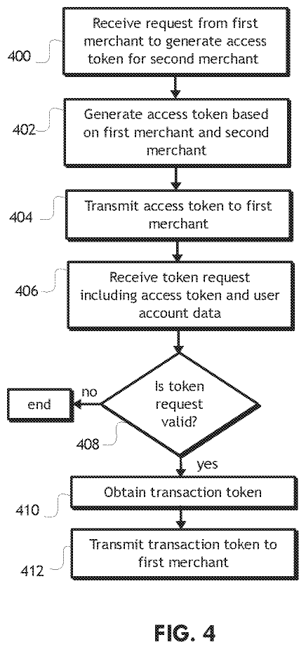

Referring now to FIG. 4, a flow diagram is shown for a system and method for authorizing a transaction according to some non-limiting embodiments or aspects. It will be appreciated that the flow diagram is shown for exemplary purposes only and that the method may include fewer, additional, and/or different steps, and that the steps may be performed in any order. The flow diagram shown in FIG. 4 is from the perspective of a transaction processing system and/or payment gateway system. At step 400, a request message is received from a first merchant system to generate an access token for a second merchant. At step 402, the access token is generated based on the first merchant and the second merchant. For example, the access token may uniquely identify the first merchant and the second merchant such that the first merchant, by possessing the access token, can prove its identity to the transaction processing system and/or payment gateway system. At step 404, the access token may be transmitted to the first merchant system and stored by the first merchant system for future use.

With continued reference to FIG. 4, at step 406, a transaction token request message is received from the first merchant system. The transaction token request message may include an access token and user profile data, including but not limited to a PAN or other account identifier. At step 408, it is determined whether the transaction token request message is valid. For example, the access token may be verified to ensure that it is authentic and that the first merchant has the authority to request a transaction token on behalf of the second merchant. If the request is not valid at step 408, the method may end. If the request is valid at step 408, the method may proceed to step 410 and a transaction token may be obtained. For example, a transaction token may be generated or retrieved from a token vault. At step 412 the transaction token is transmitted to the first merchant system, which can then pass the transaction token to the second merchant system for completing the transaction. However, as described herein, it will be appreciated that the transaction token may also be transmitted directly to the second merchant system and/or a user device operated by the user requesting the transaction.

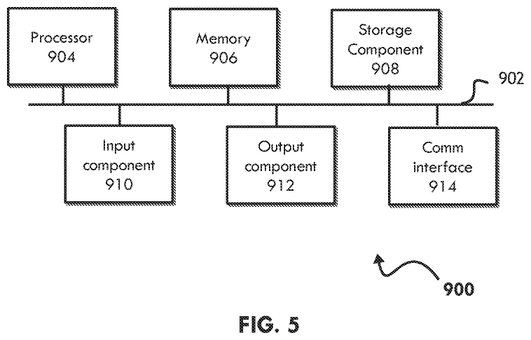

Referring now to FIG. 5, shown is a diagram of example components of a device 900 according to non-limiting embodiments. Device 900 may correspond to the user device 104, first merchant system 106, second merchant system 108, transaction processing system 102, or components thereof, in FIG. 1, as an example. In some non-limiting embodiments or aspects, such systems or devices may include at least one device 900 and/or at least one component of device 900. The number and arrangement of components shown are provided as an example. In some non-limiting embodiments or aspects, device 900 may include additional components, fewer components, different components, or differently arranged components than those shown in FIG. 1. Additionally, or alternatively, a set of components (e.g., one or more components) of device 900 may perform one or more functions described as being performed by another set of components of device 900.

As shown in FIG. 5, device 900 may include a bus 902, a processor 904, memory 906, a storage component 908, an input component 910, an output component 912, and a communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 5, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A computer-implemented method for authorizing a transaction, comprising:
registering, with a first merchant system associated with a first merchant, a second merchant system associated with a second merchant;
receiving, from the second merchant system, user data associated with a user requesting a transaction through the second merchant system;
determining, with the first merchant system, a user profile for the user based on the user data, the user profile stored on a data storage device that is not accessible to the second merchant system, the user profile including an account identifier;
obtaining, with the first merchant system, a transaction token generated based on the account identifier; and
transmitting, to the second merchant system, the transaction token.

2. The computer-implemented method of claim 1, wherein obtaining the transaction token comprises:
transmitting, with the first merchant system, a request for the transaction token to a token service; and
receiving, from the token service, the transaction token.

3. The computer-implemented method of claim 2, wherein the request comprises an access token unique to the second merchant system.

4. The computer-implemented method of claim 2, further comprising:
receiving, from the second merchant system, a registration request;
in response to receiving the registration request, redirecting the second merchant system to an authorization application; and
receiving, with the first merchant system, an authorization code associated with the second merchant system.

5. The computer-implemented method of claim 2, further comprising exchanging the authorization code for an access token.

6. The computer-implemented method of claim 1, further comprising:
receiving, with the second merchant system, the transaction token; and
initiating, with the second merchant system, a transaction based on the transaction token.

7. A computer-implemented method for authorizing a transaction, comprising:
receiving, from a first merchant system associated with a first merchant, a request for a transaction token, the request comprising user data associated with a user requesting a transaction through a second merchant system associated with a second merchant;
generating, with at least one processor, the transaction token based on an account identifier associated with the user, wherein the second merchant system does not have access to the account identifier associated with the user;
transmitting the transaction token to the first merchant system;
receiving, from the second merchant system, a transaction request message comprising the transaction token, the transaction request message corresponding to the transaction requested by the user through the second merchant system; and
processing, with at least one processor, the transaction using the transaction token.

8. The computer-implemented method of claim 7, wherein the request for the transaction token comprises an access token.

9. The computer-implemented method of claim 8, further comprising:
communicating an authorization code to the first merchant system; and
generating the access token in response to receiving the authorization code from the first merchant system.

10. The computer-implemented method of claim 9, further comprising:
receiving, from the second merchant system through an authorization application, an API access request identifying the first merchant system, wherein the second merchant system is directed to the authorization application by the first merchant system; and
in response to receiving the API access request, redirecting the second merchant system to the first merchant system.

11. A system for authorizing a transaction, comprising a first merchant system including at least one processor, the first merchant system programmed or configured to:
register a second merchant system associated with a second merchant;
receive, from the second merchant system, user data associated with a user requesting a transaction through the second merchant system;
determine a user profile for the user based on the user data, the user profile stored on a data storage device that is not accessible to the second merchant system, the user profile including an account identifier;
obtain a transaction token that is generated based on the account identifier; and
transmit, to the second merchant system, the transaction token.

12. The system of claim 11, wherein the first merchant system obtains the transaction token by:
transmitting a request for the transaction token to a token service; and
receiving, from the token service, the transaction token.

13. The system of claim 12, wherein the request comprises an access token unique to the second merchant system.

14. The system of claim 12, wherein the first merchant system is further programmed or configured to:
receive, from the second merchant system, a registration request;
in response to receiving the registration request, redirect the second merchant system to an authorization application; and
receive an authorization code associated with the second merchant system.

15. The system of claim 12, wherein the first merchant system is further programmed or configured to exchange the authorization code for an access token.

16. The system of claim 12, further comprising the second merchant system, the second merchant system including at least one processor programmed or configured to:
receive the transaction token; and
initiate a transaction based on the transaction token.

17. A system for authorizing a transaction, comprising at least one processor programmed or configured to:
receive a request for a transaction token, the request comprising user data associated with a user requesting a transaction through a second merchant system associated with a second merchant;
generate the transaction token based on an account identifier associated with the user, wherein the second merchant system does not have access to the account identifier associated with the user;
communicate the transaction token to the first merchant system;
receive, from the second merchant system, a transaction request message comprising the transaction token, the transaction request message corresponding to the transaction requested by the user through the second merchant system; and
process the transaction using the transaction token.

18. The system of claim 17, wherein the request for the transaction token comprises an access token.

19. The system of claim 18, wherein the at least one processor is further programmed or configured to:
communicate an authorization code to the first merchant system; and
generate the access token in response to receiving the authorization code from the first merchant system.

20. The system of claim 17, wherein the at least one processor is further programmed or configured to:
receive, from the second merchant system through an authorization application, an API access request identifying the first merchant system, wherein the second merchant system is directed to the authorization application by the first merchant system; and
in response to receiving the API access request, redirect the second merchant system to the first merchant system.

21.-22. (canceled)
